(19) United States
(12) Patent Application Publication
(10) Pub. No.: US 2011/0254552 A1
(43) Pub. Date: Oct. 20, 2011

(54) METHOD AND APPARATUS FOR DETERMINING GEOLOGICAL STRUCTURAL DIP USING MULTIAXIAL INDUCTION MEASUREMENTS

(76) Inventors: PETER WU, Missouri City, TX (US); Thomas D. Barber, Houston, TX (US)

(21) Appl. No.: 12/761,281

(22) Filed: Apr. 15, 2010

(51) Int. Cl. G01V 3/18

(52) U.S. Cl. 324/339

(57) ABSTRACT

A method for determining structural dip of subsurface formations includes accepting as input multiaxial induction measurements made by passing electric current through a multiaxial transmitter disposed in a wellbore drilled through subsurface rock formations. Voltages induced in a multiaxial receiver disposed at a longitudinally spaced apart location along the wellbore are detected while moving the transmitter and receiver along the wellbore. The multiaxial voltage measurements are inverted into values of formation dip magnitude and formation dip azimuth. A parameter related to shale content of the rock formations is measured, and structural dip of the rock formations is determined by selecting dip magnitude and dip azimuth values occurring when the parameter exceeds a selected threshold.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of multiaxial electromagnetic well logging instruments and methods. More specifically, the invention relates to methods and apparatus for determining geologic structural dip of subsurface rock formations using measurements from a multiaxial electromagnetic induction well logging instrument.

2. Background Art

Electromagnetic induction well logging has as a purpose the determination of electrical resistivity of rock formations. Electrical resistivity is related to parameters of interest of such formations, including fractional volume of pore space of the formation and the fluid content of the pore spaces. Generally, electromagnetic induction well logging includes moving an instrument along a wellbore drilled through rock formations. The instrument includes one or more transmitter antennas (typically in the form of wire coils) and one or more receiver antennas (also typically in the form of wire coils). Alternating current is passed through the transmitter(s) and signals are detected from the receiver(s) related to induced voltages. Characteristics of the induced voltages, for example, amplitude and phase with respect to the transmitter current, are related to the electrical resistivity of the rock formations. Typical induction logging instruments include a plurality of transmitters and receivers spaced apart from each other at selected distances along the length of the instrument so that characteristics of the rock formations may be investigated at a plurality of lateral distances (“depths of investigation”) from the center of the wellbore.

Electromagnetic induction instruments and methods of interpreting the measurements made therefrom include a device used to provide services under the service mark RT SCANNER, which is a service mark of the assignee of the present invention. The foregoing instrument includes a plurality of multiaxial (triaxial in this particular example) induction antennas. Each of the multiaxial antennas has one wire coil arranged so that its magnetic dipole moment is along the longitudinal axis of the instrument, and two additional, substantially collocated wire coils arranged so that their dipole moments are substantially perpendicular to the axis of the instrument, and substantially perpendicular to each other. One of the multiaxial antennas is used as the transmitter, and a plurality of multiaxial coils used as receiver antennas are spaced along the instrument at selected longitudinal distances from the transmitter.

An important purpose for the foregoing induction well logging instrument is to be able to determine resistivity of rock formations both parallel to the direction of layers of the rock formation (“bedding planes”) and in directions perpendicular to the bedding planes. It is known in the art that certain rock formations consist of a plurality of layers of porous, permeable rock interleaved with layers of substantially impermeable rock including substantial volume of clay minerals. Such formations, referred to as “laminated” formations, have been known to be productive of hydrocarbons and have quite different apparent electromagnetic induction resistivity parallel to the bedding planes as contrasted with perpendicular to the bedding planes.

Multiaxial induction logging instruments can also be used to determine the geodetic inclination (dip magnitude and dip azimuth) of rock formations as well as anisotropic formation resistivities. See, Barber, T., Anderson, B., Abubakar, A., Broussard, T., Chen, K. C., Davydycheva, S., Druskin, V., Habashy, T., Homan, D., Minerbo, G., Rosthal, R., Schlein, R., and Wang, H., Determining Formation Resistivity Anisotropy In The Presence Of Invasion, SPE Paper No. 90526, presented at the SPE Annual Technical Conference and Exhibition, Houston, Tex., U.S.A., 26-29 Sep. 2004 Algorithms for solving for these parameters show that the solution for formation dip is robust. See, for example, Wang, H., Barber, T., Morriss, C., Rosthal, R., Hayden, R., and Markley, M., (2006): Determining Anisotropic Formation Resistivity at Any Relative Dip using a Multiarray Triaxial Induction Tool, SPE Paper 103113 presented at the 2006 SPE Annual Technical Conference and Exhibition, San Antonio, Tex., U.S.A., 24-27 Sep. 2006. Wu, P., Wang, H., Minerbo, G., Homan, D., Barber, T., and Frey, M., (2007): Borehole Effects and Correction in OBM with Dip and Anisotropy for Triaxial Induction Tools,”, SPE Paper 110623, presented at the 2007 SPE Annual Technical Conference and Exhibition, Anaheim, Calif., U.S.A., 11-14 Nov. 2007. Multiaxial induction well logging instruments can be either wireline conveyed tools or logging-while-drilling (“LWD”) tools.

Dip can be characterized as structural (meaning the dip of entire formation layers as determined by formation boundaries) or stratigraphic (meaning dips that are internal to a specific layer or layers of rock formation). The characterization of dips calculated from multiaxial induction measurements as structural or stratigraphic is problematic. What is measured by multiaxial induction well logging instruments is the angle of the induced electric currents flowing in the formation. Although the induced currents are directed by the structural dip and by the stratigraphic dip (collectively “geological dip”), separating the two types of dip from each other from triaxial induction measurements has remained difficult.

Geological dip is therefore typically determined by inspection of wellbore wall images and by either visual or automatic fitting of sinusoids to features that cross the images. These images are generally electrical resistivity images in wireline logging, and either resistivity or density images when made using LWD tools. Geologists or other interpreters normally select the structural dips manually in places that have clear bedding planes visible, normally at the boundaries of formations known as “shales.” Selecting dip from images over a large depth range, however, is a subjective and laborious process. Consequently, dips are typically selected sparsely. Different interpreters may determine different dip results. Wellbore imaging instruments are generally pad-type devices which rely on good contact with the wellbore wall for generating high quality images. In rough wall (“rugose”) sections of the wellbore, the image quality will be compromised and as a result the selected dips will also have compromised quality. It is also known that shales are more susceptible to providing a rugose wellbore wall, because shales are more susceptible to being eroded or otherwise removed from the wellbore wall (“washed out”) by the action of drilling fluid moving through the wellbore

There continues to be a need for improved dip selection techniques usable with triaxial induction well logging instruments.

### SUMMARY OF THE INVENTION

A method for determining structural dip of subsurface formations according to one aspect of the invention includes accepting as input multiaxial induction measurements made by passing electric current through a multiaxial transmitter disposed in a wellbore drilled through subsurface rock formations. Voltages induced in a multiaxial receiver disposed at a longitudinally spaced apart location along the wellbore are detected while moving the transmitter and receiver along the wellbore. The multiaxial voltage measurements are inverted into values of formation dip magnitude and formation dip azimuth. A parameter related to shale content of the rock formations is measured, and structural dip of the rock formations is determined by selecting dip magnitude and dip azimuth values occurring when the parameter exceeds a selected threshold.

A method for well logging according to another aspect of the invention includes moving a multiaxial induction well logging instrument along a wellbore drilled through subsurface rock formations. The instrument includes at least one multiaxial induction transmitter and at least one multiaxial receiver longitudinally spaced apart from the transmitter. Electric current is passed through the transmitter. Voltages induced in the receiver are detected. The detected voltages are inversion processed into values of dip magnitude and dip azimuth of the rock formations. A parameter related to shale content of the rock formations is measured and a structural dip of the rock formations is determined at locations along the wellbore wherein the measured parameter exceeds a selected threshold.

Other aspects and advantages of the invention will be apparent from the following description and the appended claims.

### BRIEF DESCRIPTION OF THE DRAWINGS

FIG. 1A shows a triaxial induction well logging instrument being moved through a wellbore drilled through subsurface rock formations.

FIG. 1B shows an example collocated triaxial antenna.

FIG. 1C shows magnetic dipole orientations of example triaxial antennas associated with nine measurement components made by each transmitter/receiver pair.

FIG. 1D shows a logging while drilling example of an instrument used in accordance with the invention.

FIGS. 2 through 7 show simulated triaxial receiver conductivity responses for various combinations of triaxial transmitter and receiver components for various dip magnitudes and dip azimuths.

FIG. 8 shows example triaxial induction logs from an actual wellbore.

FIG. 9 shows a model of laminated thin bed rock formations having various dip magnitudes and dip azimuths.

FIG. 10 shows forward modelled triaxial induction response to the modelled formations of FIG. 9, with dip magnitude and dip azimuth calculated using inversion of the triaxial induction measurements.

FIG. 11 shows a model of laminated formations as in FIG. 9 but with added resistivity contrast.

FIG. 12 shows forward modelled triaxial induction response to the modelled formations of FIG. 11, with dip magnitude and dip azimuth calculated using inversion of the triaxial induction measurements.

FIG. 13 shows triaxial measurements and inverted dips from an actual wellbore drilled using oil based mud, and dips determined my manual selection from an image of the same wellbore.

FIGS. 14 and 15 show, respectively, dip statistics from the wellbore measurements of FIG. 13 for manually selected and inverted triaxial induction measurements.

FIG. 16 shows triaxial measurements and inverted dips from an actual wellbore drilled using oil based mud, and dips determined my manual selection from an image of the same wellbore. The dips are close to 90 degrees in a portion thereof.

FIG. 17 shows an example structure map made from dips in FIG. 16.

FIG. 18 shows triaxial measurements and inverted dips from an actual wellbore drilled using water based mud, and dips determined my manual selection from an image of the same wellbore.

FIGS. 19 and 20 show, respectively, dip statistics from the wellbore measurements of FIG. 18 for manually selected and inverted triaxial induction measurements.

FIG. 21 shows an example structure map made using the dips determined by inverting the triaxial induction measurements shown in FIG. 18.

### DETAILED DESCRIPTION

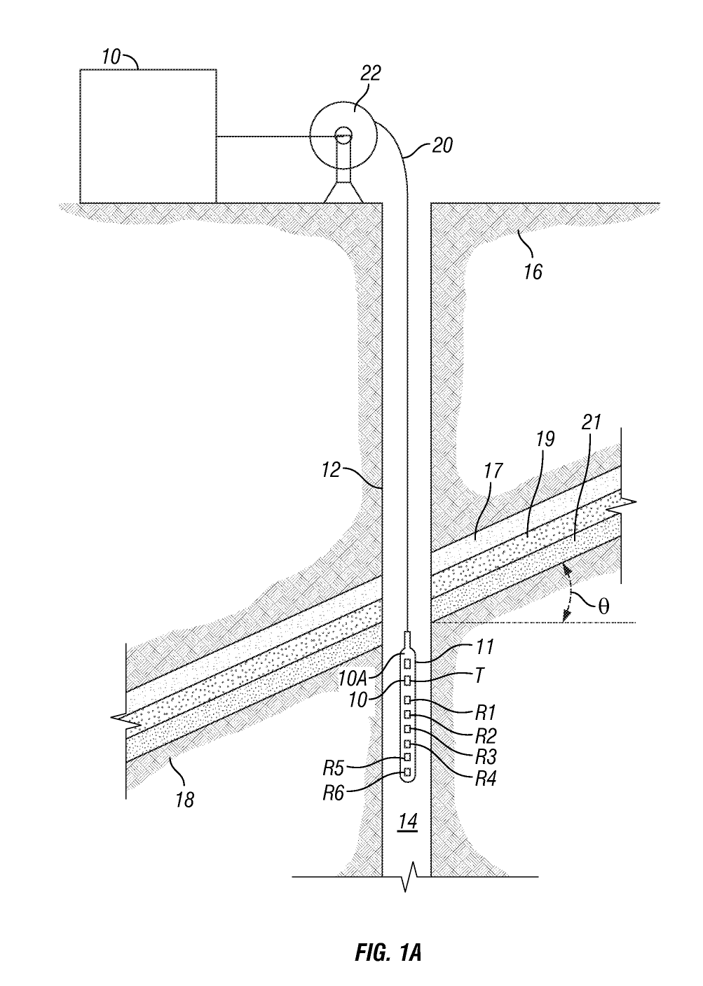

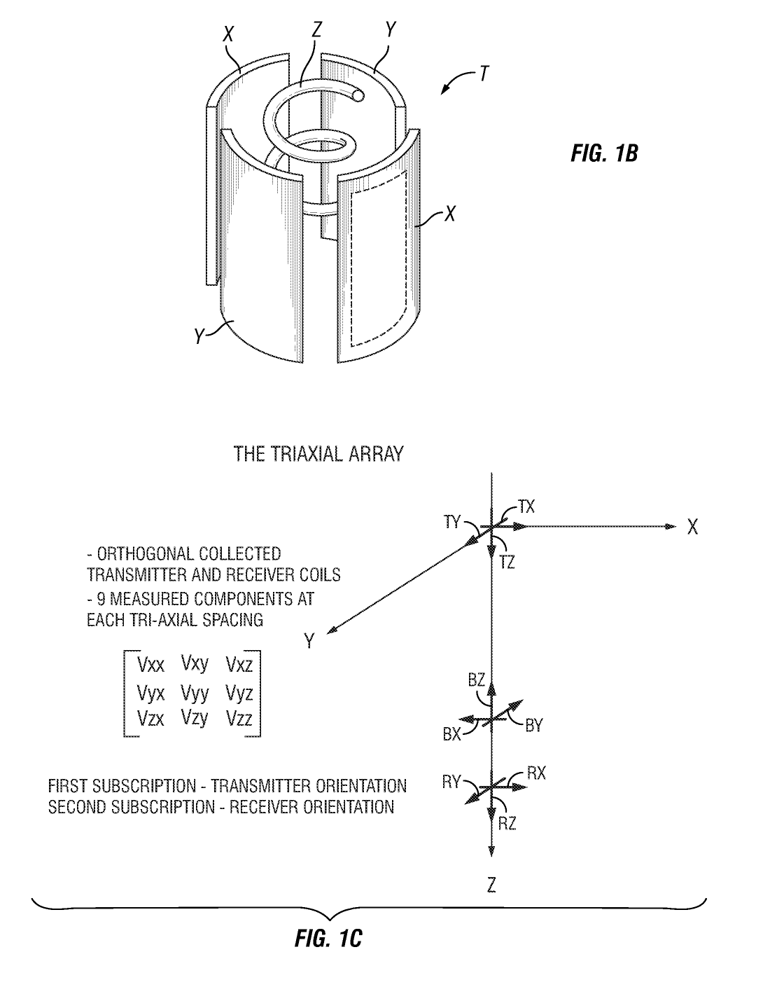

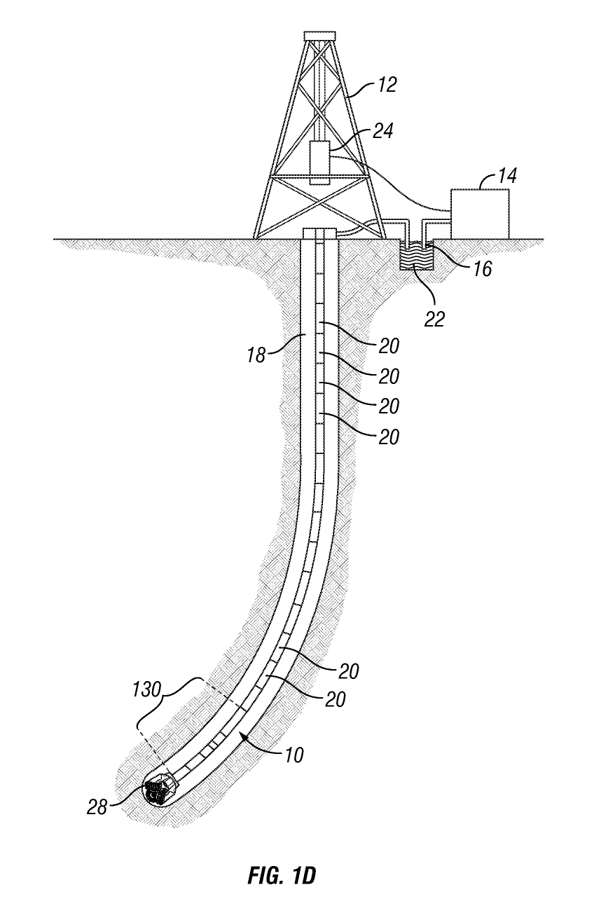

FIG. 1A shows an example of a multiaxial induction well logging instrument being used to acquire signals for processing according to various aspects of the present invention. The instrument 10 may be moved through a wellbore 12 drilled through subsurface rock formations 16, 18 at the end of an armored electrical cable 20. The cable 20 may be extended into the wellbore 12 and withdrawn from the wellbore 12 to move the instrument 10 using a winch 22 or similar spooling device known in the art. Power to operate the instrument may be provided by a recording unit 24 disposed at the surface and in electrical and/or optical communication with conductors (not shown separately) in the cable 20. Signals from the instrument 10 may be communicated to the recording unit 24 along the cable 20.

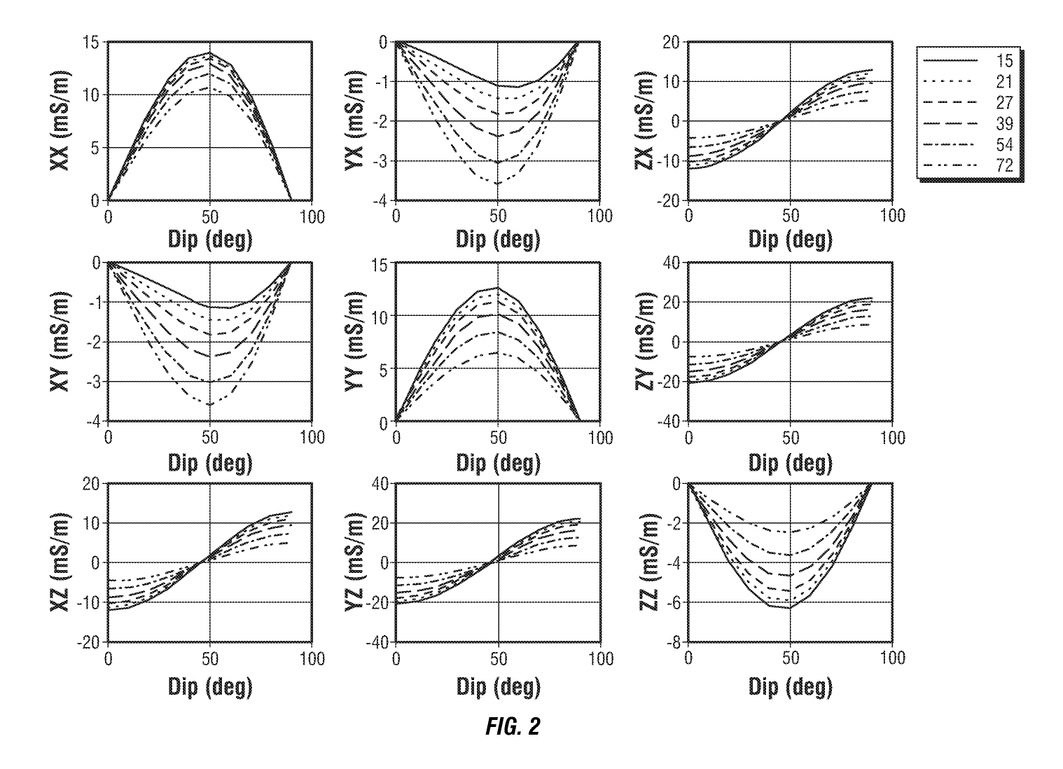

The instrument 10 may include a generally elongated housing 10A configured to move along the wellbore 12. In the present example, the instrument 10 may include a multiaxial transmitter T and a plurality of spaced apart multiaxial receivers R1 through R6 disposed at selected positions from the transmitter T. Details of the transmitter and receivers will be explained further below with reference to FIG. 2. While the present example includes one transmitter and six spaced apart receivers, the number of transmitters and receivers is not a limit on the scope of the present invention. The instrument 10 will typically includes circuitry, shown generally at 11, for conducting electrical current through the transmitter T and detecting voltages induced in the receivers R1 through R6. Signals corresponding to the detected voltages may be formatted for transmission to the recording unit 24 for recording and interpretation. The circuitry 11 may also include a sensor (not shown separately), described further below, that is responsive to the amount of clay minerals in the rock formations, and such sensor's measurements are used to identify formations that may be characterized as “shale.” The recording unit 24 may include a processor/computer (not shown separately for clarity) for interpreting measurements made by the instrument 10 according to the various aspects of the invention, and may include recording devices (not shown separately for clarity) for making time and/or depth correspondent records of measurements made by the instrument 10.

The wellbore 12 may be filled with liquid 14 called “drilling mud” used during the drilling of the wellbore 12. In some examples, the drilling mud 14 may have as its continuous phase an electrically non-conductive material such as oil. Other examples may have water as the continuous phase and are thus electrically conductive.

One of the rock formations shown at 18 may consist of a plurality of discrete layers, shown generally at 17, 19 and 21. The layers 17, 19, 21 may have different electrical resistivity from each other, such that apparent electrical resistivity of the formation 18 may be different when measured in a direction parallel to the lateral extent of the layers 17, 19, 21 (“along the bedding planes”) than when measured perpendicular to the bedding planes. As shown in FIG. 1, it is also the case that the bedding planes of the formation 18 will intersect the wellbore 12 other than perpendicularly.

Although the wellbore 12 is shown in FIG. 1 as being approximately vertical, as is known in the art, wellbores are commonly drilled along trajectories that include non-vertical or even horizontal portions. The angle of intersection of the bedding planes of the formation with the wellbore, which may be referred to as “apparent dip”, is indicated by θ. The angle of intersection is a result of a combination of the inclination of the wellbore 12 from vertical and the geodetic attitude (“dip”) of the formation 18.

FIG. 1B shows an example of a multiaxial antenna coil that may be used for one or more of the transmitter (T in FIG. 1) or receivers (R1 through R6 in FIG. 1). The coil shown in FIG. 2 is a triaxial antenna coil with dipole moments along three mutually orthogonal axes and may include two “saddle” type coils arranged to conform approximately to the shape of the instrument housing (10A in FIG. 1). The saddle type coils may enclose areas on opposite sides of the housing (10A in FIG. 1) so as to have dipole moment oriented substantially perpendicular to the axis of the instrument (10 in FIG. 1) and substantially perpendicular to each other. Two such enclosed areas are shown respectively at X and Y in FIG. 2. The triaxial coil may also include a solenoid type coil, shown at Z that has dipole moment substantially coaxial with the axis of the instrument. The coil arrangement shown in FIG. 2 provides magnetic dipoles along each of three mutually orthogonal axes having a common midpoint therebetween. The example coil shown in FIG. 2 is only one type of multiaxial antenna coil that can be used in accordance with a measurement and interpretation technique according to the invention. Other arrangements of antennas may include oblique angle coils. Accordingly, the antenna arrangement shown in FIG. 2 is not intended to limit the scope of the present invention.

Referring to FIG. 1C, the various measurements made by each of the receivers (R1-R6 in FIG. 1A) may be identified by the particular one of the coils that was energized at the transmitter and the particular one of the coils at each receiver for which a corresponding voltage is detected. Thus, for each receiver, there are nine component measurements: a detected voltage for each of the X, Y and Z receiver coils corresponding to energizing of each of the X, Y and Z transmitter coils. In the explanation below, each component measurement will be identified by a letter pair corresponding to the particular transmitter coil and the particular receiver coil. The nine component measurements are thus identifiable by the references XX, XY, XZ, YX, YY, YZ, ZX, ZY and ZZ. Component measurements that use the same transmitter and receiver dipole moment directions, i.e., XX, YY, ZZ are typically referred to as “direct coupled” component measurements. Component measurements that use a different transmitter dipole moment than the one used for the receiver, e.g., XY, XZ, YX, YZ, ZX, ZY, are typically referred to as “cross component” or “cross coupled” measurements. As shown in FIG. 1C, each receiver typically includes a corresponding triaxial balance coil Bx, By, Bz to attenuate effects of direct inductive coupling between the transmitter and each receiver.

It is to be clearly understood that instrument conveyance into and out of the wellbore by armored cable is only one manner of conveyance of an instrument to be used according to the invention. Any other form of wellbore conveyance, including without limitation, drill pipe, slickline, jointed tubing and coiled tubing may be used to convey the instrument. Accordingly, the method of conveyance of the instrument is not a limitation on the scope of the present invention. An example of conveyance of the instrument on a pipe string is for logging while drilling (“LWD”) during drilling of the wellbore or during movement of the pipe is shown in FIG. 1D. The multiaxial electromagnetic well logging instrument 10Bin this example is an LWD instrument which forms part of a drilling assembly. The drilling assembly can include threadedly coupled segments 120 (“joints”) of drill pipe which are raised and lowered by a drilling rig 112 at the earth's surface. The drilling assembly also includes a bottom hole assembly (BHA) 130 that includes the instrument 10B, a drill bit 128, and may include various other devices (not shown separately) such as drill collars, mud motor, stabilizers, and directional drilling tools. The drilling assembly is rotated by a rotary table, or more preferably by a top drive 124 or similar device on the rig 112. Drilling fluid (“mud”) 116 is lifted from a tank or pit 122 by mud pumps 114 and is pumped through the drilling tool assembly and out of nozzles or jets in the drill bit 128 to cool the bit and to lift drill cuttings through the wellbore where they are separated from the returning mud 116 at the earth's surface. In some examples, the instrument 10B includes a telemetry system (not shown separately) to communicate at least some of the measurements made thereby substantially in real time to the earth's surface for interpretation and/or recording. As explained with reference to FIG. 1A, such interpretation and recording may be performed in a recording unit (24 in FIG. 1A). Many types of such telemetry systems are known in the art. See, for example, U.S. Pat. No. 4,968,940 issued to Clark et al. Measurements may also be recorded in a storage device (not shown in FIG. 1) in the instrument 10B, of any type known in the art, such as one also disclosed in the Clark et al. '940 patent. The instrument 10B may also include internal data storage (not shown separately) for recovery of the measurements after the instrument is removed from the wellbore. The instrument 10B may include one or more multiaxial transmitters and receivers as explained with reference to FIGS. 1A, 1B and 1C.

The triaxial induction instrument is well known to be sensitive to formation dip. Generally speaking, the three transmitter coils produce electric current densities in the formation that flow parallel to orthogonal planes oriented with their normals in the X, Y, and Z directions. The foregoing directions are defined by the directions of the magnetic dipole moments of each of the three transmitter coils. Inhomogeneties in the rock formations will distort the currents flowing therethrough, and the electromagnetic fields at the receivers are different from what would have existed if the formation were homogeneous. One type of distortion is the dip of the anisotropy of the formation. Moran and Gianzero (1979) give equations for the fields in such a situation, and these may be readily solved for the dip angle. See, Moran, J. H., and Gianzero, S. C., Effects of Formation Anisotropy on Resistivity-Logging Measurements, Geophysics, 44, (1979) 1266-1286. When dip magnitude and dip azimuth (rotational orientation with reference to a selected axis, usually the X antenna direction) have been determined with reference to the directions defined by the instrument antenna magnetic dipole moments, such magnitude and azimuth can be converted to geodetic magnitude and azimuth by determining the instrument's geodetic orientation. The latter is typically performed using a directional survey device (not shown). Such devices are well known in the art.

Other methods for determining dip from multiaxial electromagnetic induction measurements are also known in the art (e.g., Wang, et al., 2006, Wu, et al., 2007, Wu, et al., 2009). These methods, however, calculate the dip of eddy currents flowing in the formation. Distortions to the current flow may result from several geological sources, e.g., structural dip, stratigraphic dip, fractures, etc.

In contrast to the formation imaging instruments used to determine dip as explained in the Background section herein, the axial resolution of the induction instrument is much lower. The measurements made by the electromagnetic induction instrument reflect the averaged properties of the formations within a radius of 3-5 ft for measurements made by the receivers closest to the transmitter. On the other hand, the lower resolution measurements made by the induction instrument are less susceptible to wellbore wall rugosity than the measurements made by an imaging instrument.

As the instrument (10 in FIG. 1) is moved along the wellbore, a set of values of Rh (horizontal resistivity), Rv (vertical resistivity), dip magnitude and dip azimuth is obtained through an inversion algorithm for each measurement sample interval. Usually the measurement sample interval is 3 inches. Therefore, the instrument cannot resolve properties of each individual thin bed layer with thickness in the centimeter range. Instead, averaged properties within the instrument's axial resolution span are measured. Thinly laminated sand/shale sequences will appear as uniform, anisotropic formations. The Rh, Rv, dip magnitude, and dip azimuth of the equivalent anisotropic formation can be obtained by inversion of the nine measurement components as explained above. The dip magnitude and dip azimuth thus obtained usually will be close to those of the bedding planes (formation boundaries) measured by imaging tools for a uniform, flat-layered formation. Due to the large difference between the axial resolution of the imaging instrument and the induction instrument, any centimeter length scale lateral or axial variation of the formation electrical properties could cause differences in the calculated dip magnitude and dip azimuth between the imaging instrument and the induction instrument. It is known in the art from observation of imaging instrument measurements that rock formations are mostly heterogeneous in the sub-centimeter length scale. Therefore, it would ordinarily be expected when comparing the dip magnitude and dip azimuth determined by multiaxial induction measurements and imaging instrument measurements that the magnitudes and azimuths will be different.

The “structural dip” of the formation (that is, the geodetic inclination and direction of the formation layer boundaries) is usually obtained from shaly formation zones because shale has more uniform electrical properties and has better defined formation layer boundaries. Sandy zones and carbonate features generally have less well defined layer (“bed”) boundaries and in the case of sandy zones often contain the stratigraphic complication of crossbedding, which may have different dip magnitudes and dip azimuths than those of the bed boundary.

In the present invention, it will be demonstrated using example data from actual wellbores that there is generally a good match between the triaxial induction-determined dips measured in shales and an interpreter's manual selection of structural dip from imaging instrument measurements. In a method according to the invention, a lithology indicator (e.g., measurements from the sensor in the circuits 11 in FIG. 1A) can be used to determine which formations have sufficient shale content such that dips calculated from the induction measurements may be deemed to be reliable. In such cases, the processor in the recording unit (24 in FIG. 1A) can display the triaxial induction dips, for example, in a different color when the formation is sufficiently shaly. This will help ensure that the geologist or other data interpreter uses the dips from the more reliable shale zones. Lithology indicators (sensors) could be gamma ray, combination neutron porosity and bulk density, mineralogy output from neutron capture spectroscopy measurements, or other measurements that are sensitivity to clay content. Using dips calculated in shale zones as explained above, it is also possible to construct a formation structure map using the relatively densely sampled dip and azimuth information from triaxial induction instrument, and such construction can be considerably easier than when using sparely sampled interpreter-selected dips from imaging measurements.

In determining the viability of a method according to the invention, extensive modeling was performed to study the sensitivity of the triaxial induction measurements to dip magnitude and dip azimuth. Modeling was also performed to determine the vertical response of the dip magnitude and dip azimuth from triaxial induction measurement. In FIGS. 2-4, each explained further below, apparent conductivities for each combination of transmitter and receiver orientation, i.e., XX, XY, XZ, YX, YY, YZ, ZX, ZY, ZZ are displayed for each of the six multiaxial receivers on the RT SCANNER instrument mentioned above. Apparent conductivity is on the vertical axis of each plot and dip magnitude is shown in the horizontal axis of each plot.

FIG. 2 shows modeled variation of all 9 components of the apparent conductivity tensor with respect to dip magnitude, modeled in increments of 5 degrees of dip variation in a typical low conductivity (Rh=1 ohm-m) and low anisotropy ratio (Rv/Rh=1.2) formation. The dip azimuth angle is fixed at 60 degrees with respect to the instrument frame of reference. On each plot shown in FIG. 2, there are 6 curves 40, 42, 44, 46, 48, 50, one for each of the 6 receiver spacings from the transmitter (see FIG. 1) in the RT SCANNER instrument described above.

The dip magnitude and dip azimuth angles are output from an inversion algorithm using all 9 components of the apparent conductivity tensor. Two observations can be made from the plots in FIG. 2. First, there is no “blind spot” for the dip inversion. For some components, such as XX, YY, ZZ, XY, and YZ, the sensitivities are near zero at dip magnitude near 0 and 90 degrees. However the low sensitivities at these two limits are compensated by the XZ, ZX, YZ, and ZY components which are at maximum sensitivity. It is therefore desirable to use all 9 components of the conductivity tensor for the inversion. Using a subset of the tensor, such as the ZZ component only, may result in high dip uncertainty near the “blind spot” (0 and 90 degrees) for such components. Second, at low anisotropy ratios, e.g., Rv/Rh=1.2, the dip magnitude sensitivity for all the 9 components is lower than 20 mS/m. This level of sensitivity is approaching the limit below which the accuracy of the dip may be marginal. It is worth mentioning here that in isotropic formations, i.e., Rv/Rh=1, the triaxial induction measurements have no sensitivity to dip and azimuth and therefore the inversion will yield correct resistivities with Rh=Rv, and will generated random dip magnitude and dip azimuth. In fact, in the electromagnetic sense, the dip and azimuth are undefined if Rh/Rv=1. Fortunately, the foregoing conditions rarely occur in subsurface rock formations. Situations where the foregoing conditions may occur include, for example, in well sorted, thick (greater than largest axial distance between transmitter and receiver) water filled sand, the Rv/Rh may approach this lower limit such that the dip magnitude and dip azimuth are not accurately determinable.

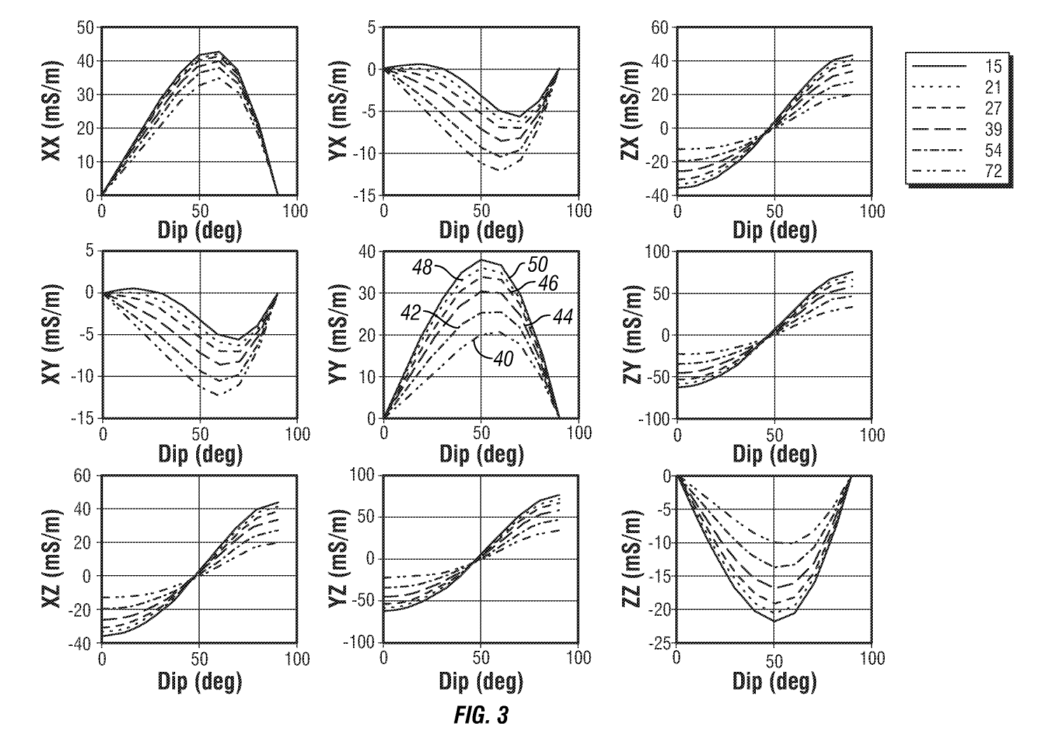

The dip sensitivity of the multiaxial induction measurements will increase rapidly as the Rv/Rh ratio increases from near 1 to 2. Shown in FIG. 3 is the modeled variation of apparent conductivity in 5 degree increments for the same simulated formation as in FIG. 2 except the Rv/Rh ratio is 2. All the conductivity tensor components, shown by each of the six curves 40-50 have significant increase in sensitivity compared with the case of Rv/Rh=1.2. Modeling has demonstrated that the increase in dip sensitivity continues until about Rv/Rh=10, above which the increase in sensitivity tapers off.

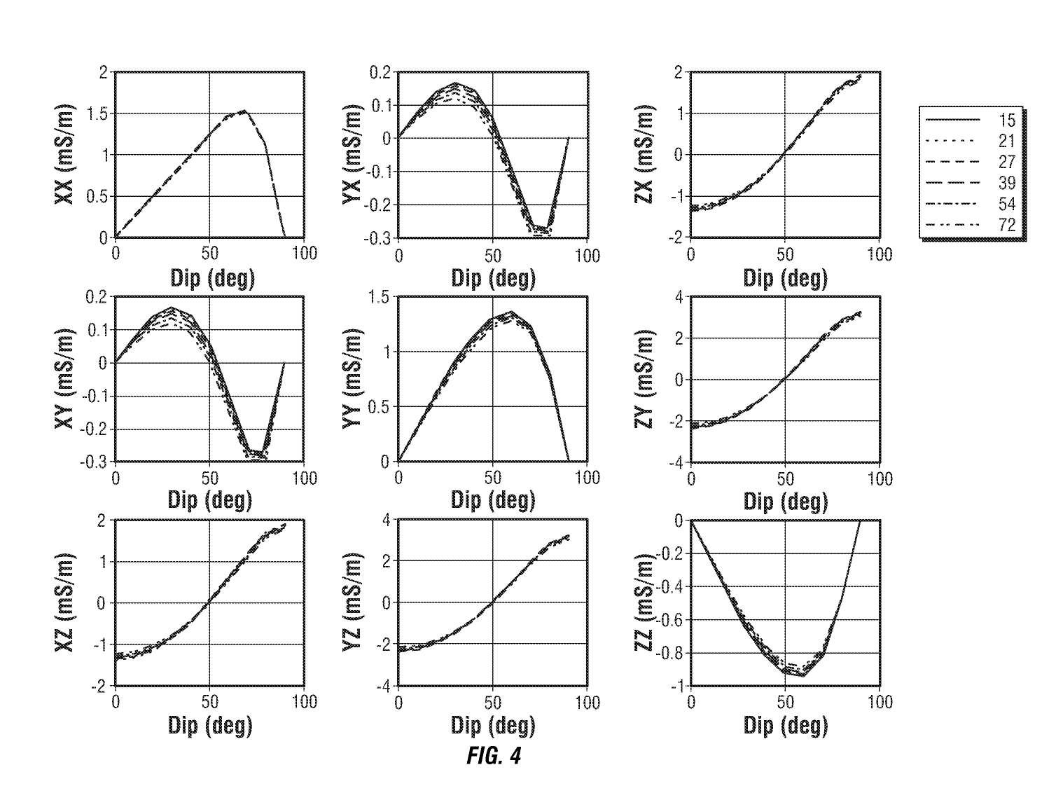

Another condition which may result in low accuracy of dip magnitude and dip azimuth is high resistivity formation (i.e., low conductivity). The amplitude of the triaxial apparent conductivity tensor generally decreases rapidly as the formation conductivity decreases. Shown in FIG. 4 is modeled variation of apparent conductivity in 5 degrees increments of dip magnitude in a high resistivity formation with Rh=50 ohm-m, Rv/Rh=5, and dip azimuth fixed at 60 degrees. Despite the high Rv/Rh ratio, the sensitivity of all 9 components of the conductivity tensor are below 2 mS/m. This case may represent the upper limit of formation resistivity, above which large errors in inversion calculated dip may occur.

The above analysis of the sensitivity to the dip magnitude was performed with the dip azimuth fixed at an arbitrary value of 60 degrees. Changing the azimuth to other values will not alter the general trend of the data nor will it change the conclusions.

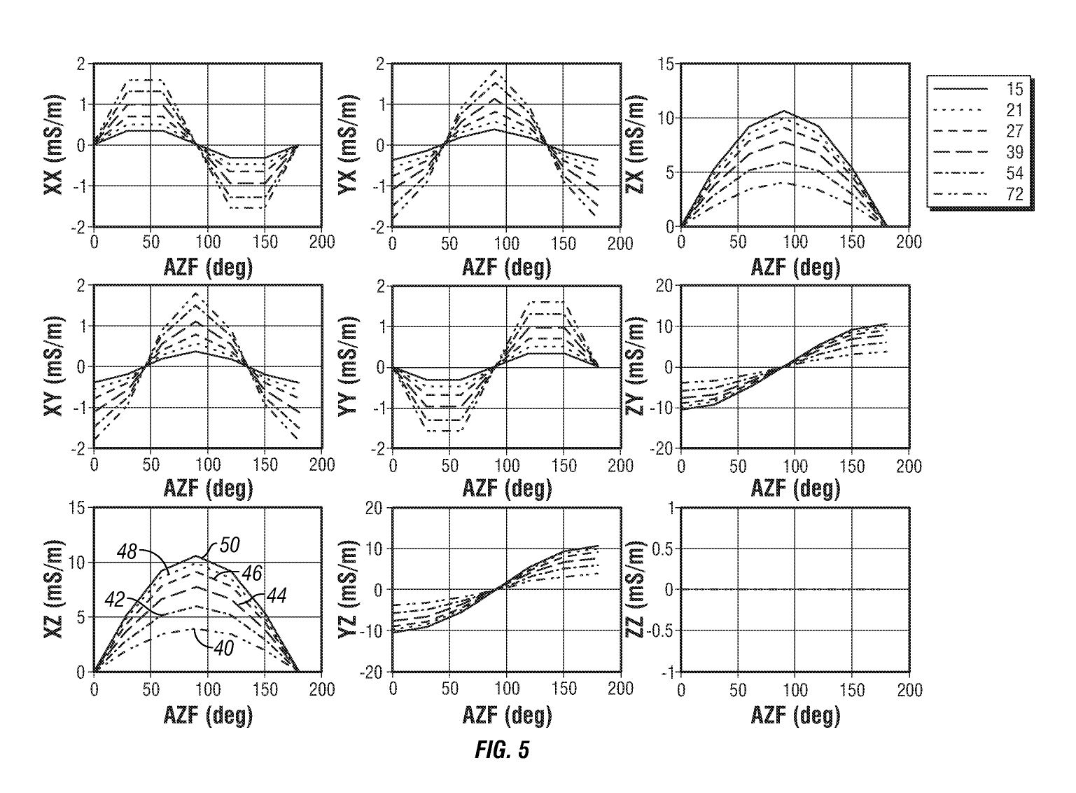

In each of FIGS. 5-7, explained individually below, the variation of all 9 components of the apparent conductivity tensor for each of the six receiver spacings (curves 40-50, respectively) were modeled in 5 degrees of azimuth increments, and the dip magnitude was fixed at 30 degrees. FIG. 5 shows results for a typical low conductivity (Rh=1 ohm-m) and low anisotropy ratio (Rv/Rh=1.2) formation. The range of azimuth is from 0 to 360 degrees, however, the results from 180 to 360 degrees are the minor image of the results generated in the range 180 to 0 degrees. Therefore, only the results in the range 0 to 180 are displayed. It should be noted that the ZZ component is independent of the azimuth variation and therefore the ZZ component has zero azimuthal sensitivity. It is also important to note here that at zero dip magnitude, the dip azimuth is undefined and the sensitivity to dip azimuth is zero for all 9 tensor components. The azimuth information is mainly derived from the XZ, ZX, YZ, and ZY tensor components, which usually have higher signal-to-noise ratio (S/N) than the XY and YX components. These results also show that there is no “blind spot” for the azimuth determination. The azimuth sensitivity is adequate for this example but it is approaching the Rv/Rh limit below which the azimuthal accuracy will be marginal.

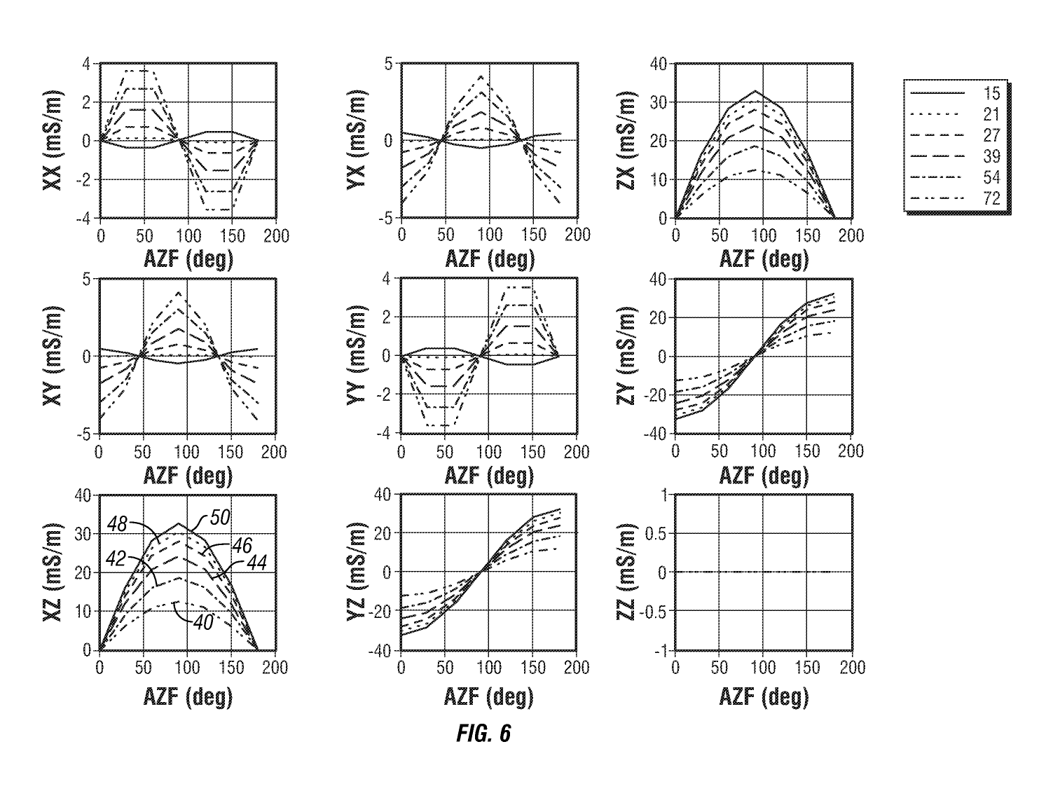

The dip azimuth sensitivity will also increase rapidly as the Rv/Rh ratio increases from near 1 to 2. Shown in FIG. 6 is the variation of apparent conductivity modeled in 5 degrees azimuth increments for all six spacing for the case of Rv/Rh=2. All the tensor components demonstrate significant increase in sensitivity compared with the case of Rv/Rh=1.2. The rapid increase in sensitivity continues until Rv/Rh=10, above which the increase in sensitivity tapers off.

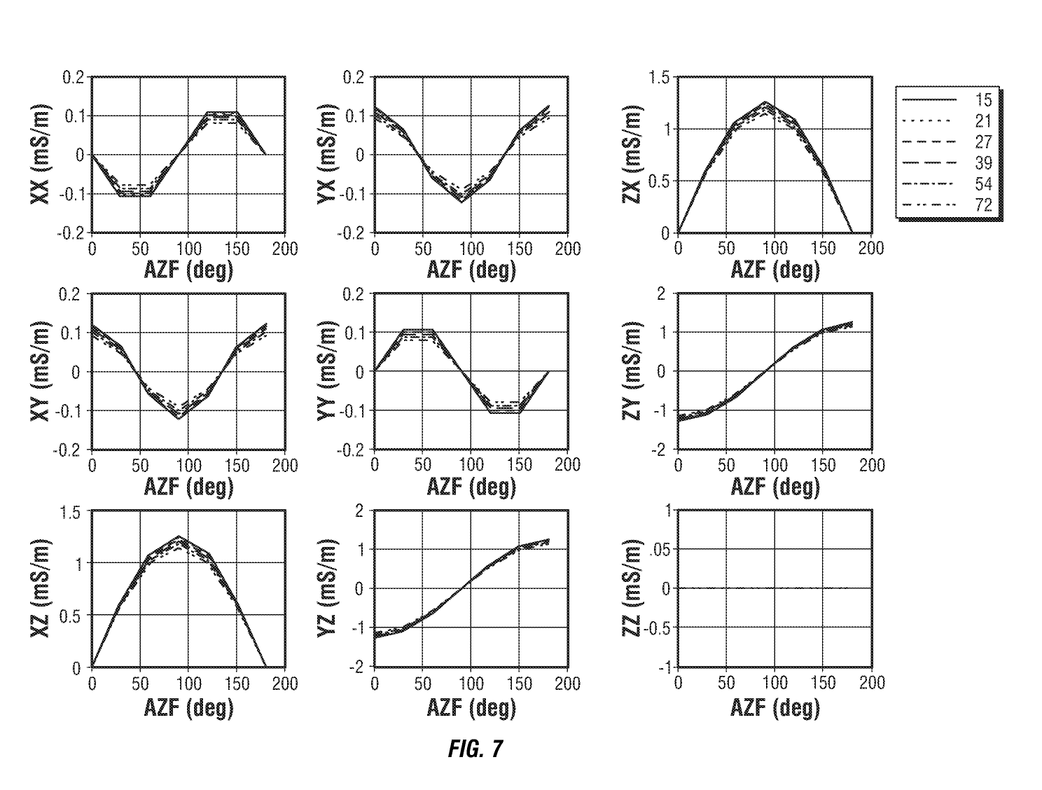

The dip azimuth sensitivity also decreases rapidly with the conductivity of the formation. Shown in FIG. 7 is the sensitivity of azimuth in a high resistivity formation with Rh=50 ohm-m, Rv/Rh=5, and dip magnitude at 30 degrees. The sensitivity of all 9 tensor components are below 1.5 mS/m. This case represents the upper limit of formation resistivity above which large error in azimuth may occur.

The foregoing results suggest that as a rule of thumb, accurate dip magnitude and dip azimuth inversion can be obtained from multiaxial induction measurements in anisotropic formations with Rv/Rh ratio higher than about 1.2 and Rh values lower than about 50 ohm-m. Near zero dip, azimuth is undefined and therefore has high uncertainty. In isotropic formations, Rh/Rv ˜1, both dip magnitude and dip azimuth are undefined electrically, and therefore the inversion results will have high dip uncertainty.

The foregoing sensitivity analysis assumes uniformly anisotropic formations, which is also the assumption used in the inversion processing. The inversion results will be valid in the middle of a thick bed. A bed boundary with a large resistivity contrast has a substantial effect on the accuracy of the inversion results near the bed boundary. Many studies have been published concerning the shoulder bed effects on the apparent resistivity (Rh and Rv) logs made from multiaxial induction measurements. There are relatively few studies, if any, however, on the shoulder bed effects of the dip magnitude and dip azimuth determined from multiaxial induction measurements.

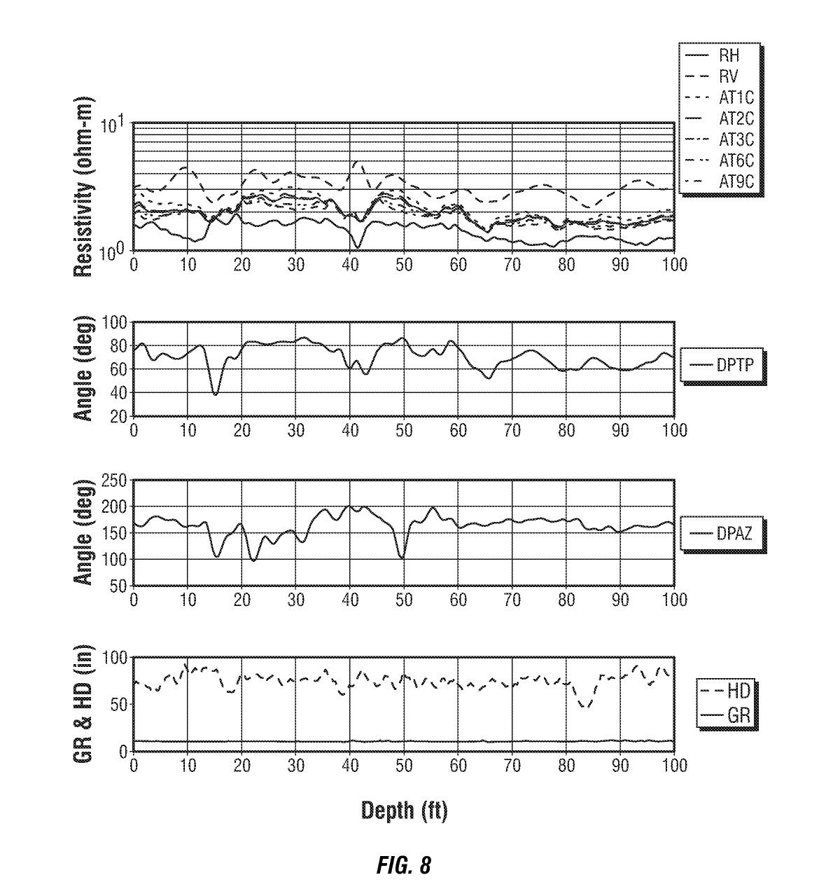

Thin bed responses of the dip magnitude and dip azimuth calculated by inverting multiaxial induction measurements were studied using modeled data generated by a 3D finite difference procedure. The modeled cases are inspired from actual field logs such as the one shown in FIG. 8. The Rh and Rv (curves 54 and 52, respectively) together with 2 foot resolution array induction instrument logs (curves 56) are shown in the upper display grid (“track”). It will be appreciated by those skilled in the art that the array induction curves may be generated by measuring the ZZ component of the conductivity tensor at each of the receivers on the instrument. The second and third display tracks are the true dip magnitude (curve 58) and dip azimuth (curve 60), respectively. The wellbore is substantially vertical throughout; therefore true and apparent dips are essentially the same. A gamma ray (sensor 11 in FIG. 1), curve 62 and wellbore diameter (caliper), curve 64, are shown in the bottom display track. The gamma ray curve 62 indicates that the formation is a laminated sand shale sequence. The Rh 54 and Rv 52 logs show small variations and absence of beds with strong resistivity contrast. The Rh 54 varies in the 1˜2 ohm-m range and the Rv/Rh ratio varies from 1.3 to 4.5. These conditions should produce good sensitivity for dip and azimuth measurements. The array induction logs (curves 56) are generally close to the midpoint between Rh 54 and Rv 52, indicating high dip magnitude formation. Theoretically, for 90 degree dip angle in an anisotropic formation, the ZZ component derived array induction logs should be the geometric mean of Rh and Rv, or at the center between the logarithmically scaled Rh 54 and Rv 52 curves. For zero dip anisotropic formation, the AIT logs should match the Rh curve 54. The array induction curves 56 move very close to the Rh curve 54 around 15 ft, which matches the lowest dip angle location, at 38 degrees, of this zone. The relative position of the array induction curves 56 with respect to the Rh 54 and Rv 52 curves is a very coarse qualitative indicator of whether the apparent dip of the formation is “high” or “low”. The dip magnitude 58 and dip azimuth 60 curves show sharp variations in the example of FIG. 8. For instance, near 15 ft, the dip changes from 80 to 38 and then back up to 70 degrees within five feet axially along the wellbore. The dip azimuth 60 also exhibits a sharp change within the same five foot interval. This sharp variation prompts the question of accuracy of thin bed response of the dip magnitude and dip azimuth inverted from multiaxial induction measurements.

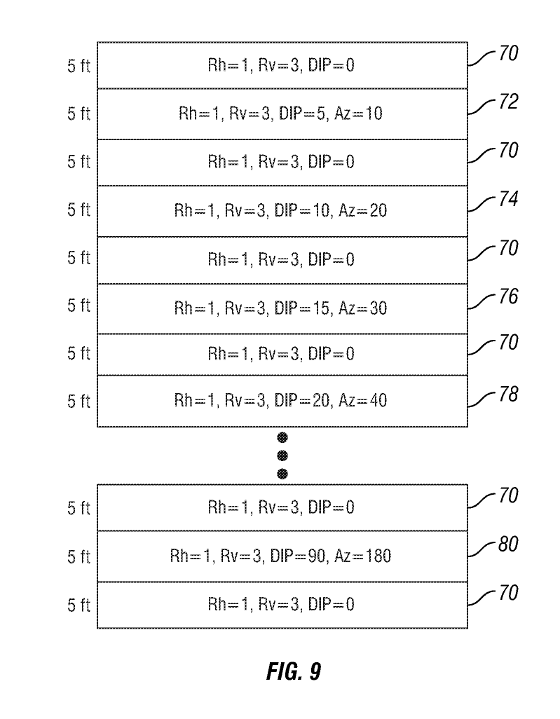

To answer the foregoing question, 3D finite difference code was used to generate synthetic multiaxial induction data for a bed sequence as shown in FIG. 9. The background formation of this bed sequence is anisotropic with Rh=1 ohm-m, Rv=3 ohm-m, and dip angle=0 degrees, shown by layers 70. Every 5 feet, a 5 foot thick bed of the same Rh and Rv values but with a different dip magnitude and dip azimuth is inserted into the background formation, shown by layers 72, 74, 76, 78, 80. The dip magnitudes of the 18 inserted beds vary from 5 degrees to 90 degrees in increments of 5 degrees. The dip azimuths of the same inserted beds vary from 10 to 180 degrees in increments of 10 degrees.

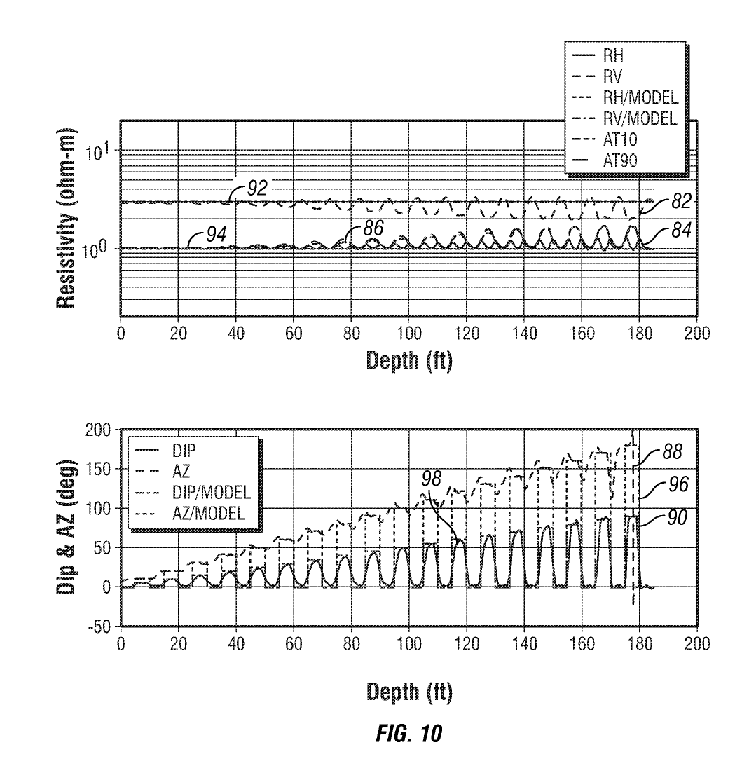

These synthetic data were processed by the inversion algorithm described in Wu 2007 (cited hereinabove), and the output curves are shown in FIG. 10. The top display track shows the resistivity logs. Inverted Rh and Rv curves are shown at 84 and 82, respectively. The model parameters for Rh and Rv are shown at 94 and 92, respectively. The 2-ft resolution array induction curves are shown at 86. The dip magnitude and dip azimuth are shown in the lower track. The inverted dip and azimuth logs are shown at 90 and 88, respectively. The model parameters for dip and azimuth are shown by curves 98 and 96, respectively. The Rh curve 84 reproduces the model parameter curve 94 well for low dip thin beds. Small horns in the upward (higher apparent resistivity) direction start appearing at the bed boundaries for beds with dip magnitude higher than about 40 degrees (beds deeper than 80 ft). These horns are caused by the 3D effect which is not accounted for in the inversion procedure. The 3D effect on the Rv curve 82 is much more pronounced as compared with the Rh curve 84. The 3D effect causes the Rv curve 82 to have downward horns at the bed boundaries. The Rv curve 82 usually has a much longer range bed boundary effect, or poorer axial resolution than the Rh curve 84. Therefore, the downward horns from the two adjacent bed boundaries are merged together such that the Rv log for the 5-ft zero dip background zone appears to be at a lower resistivity value. Consequently, the overall shape of the Rv curve 82 will appear to be out of phase with the Rh curve 84. The modeling also confirmed that the array induction curves 86 will progressively deviate from the correct Rh value as the dip magnitude increases. As the dip magnitude approaches 90 degrees, the array induction curves 86 have the value of the geometric mean of Rh and Rv. The present example demonstrates vividly the dip effect on array induction measurements. Often, array induction measurements show a significant spike in a zone where the Rh and Rv curves appear to be quite constant with only small ripples. There is some question whether the spike represents a thin bed missed by the triaxial inversion. However, if the array induction curves spike lines up with a spike in the apparent dip magnitude curve, it appears more than likely the array induction curve spike is caused by the high dip effect in an anisotropic formation.

In contrast to all the 3D effect complications on the Rh 84 and Rv 82 curves, the inverted dip magnitude 90 and dip azimuth 88 curves on the lower track match well to the respective model parameters 96, 98. Both dip 90 and azimuth 88 curves transition from the background bed value to the dipping bed value smoothly without significant horns or spikes. The transition zones are surprisingly small despite the sharp changes in dip and azimuth. Both dip 90 and azimuth 88 curves reach the correct bed dip and azimuth at the centers of the 5 foot thick dipping beds. The dip of the background formations in the present example, as shown in FIG. 9, is zero. Therefore, any azimuth angle will be a correct answer for the inversion. The foregoing explains why the azimuth curve 98 may take different values on the two side of the dipping bed to approach the bed azimuth value at the center of the bed. In the example of FIG. 10, on the shallow side of the dipping bed boundary the azimuth curve 98 goes from a high value to approach the true bed azimuth and on the deeper side of the boundary the azimuth curve 98 goes from a lower value to approach the true bed azimuth. For the bed having dip magnitude of 90 degrees (just below 180 ft), the azimuth curve 98 flips from 180 degrees to zero degrees at the middle of the bed. This is not a failure of the inversion. For 90 degrees dip magnitude, an azimuth of 180 degrees and zero degree are actually identifying the same geometry of a bed with east-west strike direction.

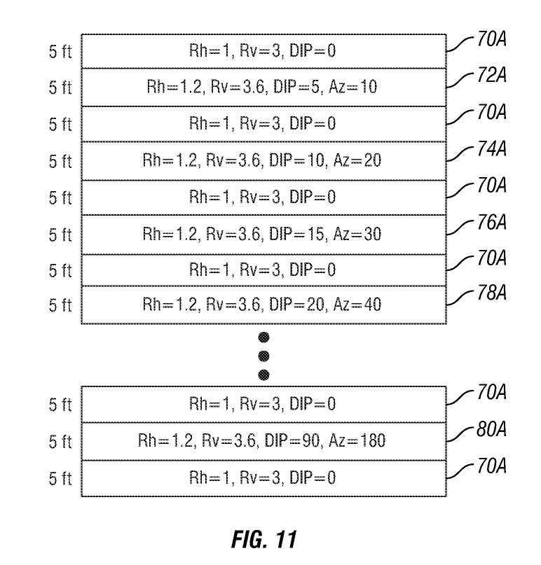

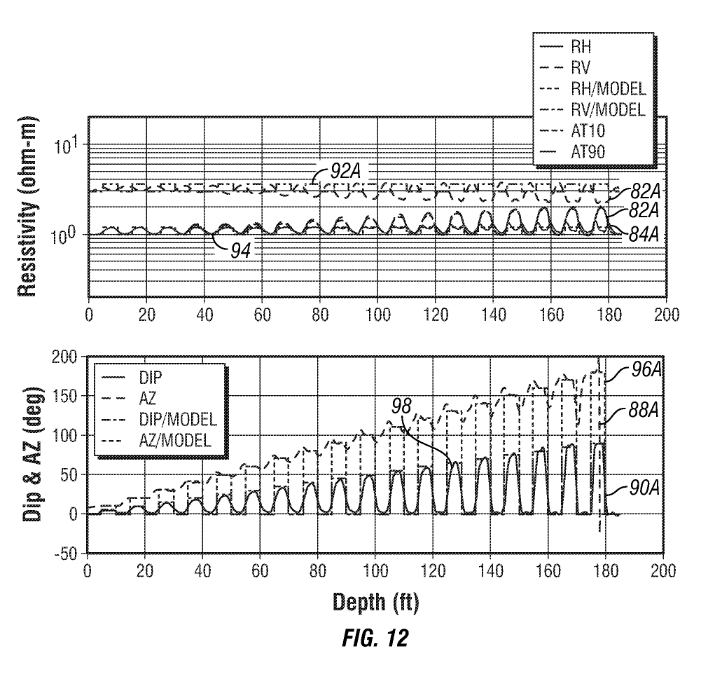

In the above modeling example, the dipping beds and the background beds have the same Rh and Rv values. The purpose of such constraint on the model was to isolate the effects of only the dip magnitude and azimuth contrast. In another example a moderate resistivity contrast is added to the dipping beds to simulate the field condition of the curves shown in FIG. 8. For the present model, the resistivities of the dipping beds were set to Rh=1.2 ohm-m and Rv=3.6 ohm-m, which is a 20% resistivity contrast with respect to the background. The parameters of the present bed sequence are described in FIG. 11. Background formations are shown at 70A, and dipping layers are shown at 72A through 80A, respectively. The inverted curves from the synthetic data made from the model in FIG. 11 are plotted in FIG. 12 in the same format as that for FIG. 10. With resistivity contrast included, the “horns” in the Rh curve for the dipping beds with dip magnitude less than 60 degrees (beds above 120 foot depth) actually looks inconspicuous compared with that of the no resistivity contrast case because the resistivity profile of the bed sequence masked the small horns at the bed boundaries. For small dip angle (<60 degrees) beds, the Rh curve 82A reached the bed Rh parameter value at the center of the bed. For dipping beds with a dip angle higher than 60 degrees, the horns at the bed boundaries on Rh curve 82A look similar to the case of no resistivity contrast (82 in FIG. 10). At the center of the dipping beds, the Rh curve 82A reads slightly lower than the bed Rh parameter value. The Rv curve 84A also looks very much like that for the no resistivity contrast case (84 in FIG. 10). Most of the deviation of the Rv curve 84A from the bed resistivity parameter value are caused by the 3D effect of changing dip and azimuth rather than resistivity contrast of the shoulder beds.

The dip 88A and azimuth 90A curves for the bed sequence with resistivity contrast (FIG. 11) look almost the same as the corresponding curves for the first bed sequence (FIG. 9) without resistivity contrast. Both dip 88A and azimuth 90A curves reach the correct model parameter values at the center of the five foot thick dipping beds. In summary, it has been demonstrated through 3D modeling that the dip and azimuth inverted from triaxial induction instrument measurements can resolve the correct dip and azimuth values at the center of five foot thick beds with moderate resistivity contrast. The modeling results suggest that in an environment such as the one shown in FIG. 8 where the Rv/Rh ratio is higher than about 1.2 and the Rh value is lower than about 50 ohm-m the dip and azimuth logs can be considered reliable. It has also been shown that the relative position of the array induction curves with respect to the Rh and Rv curves can be used as a coarse qualitative indicator for high or low apparent dip of the formation.

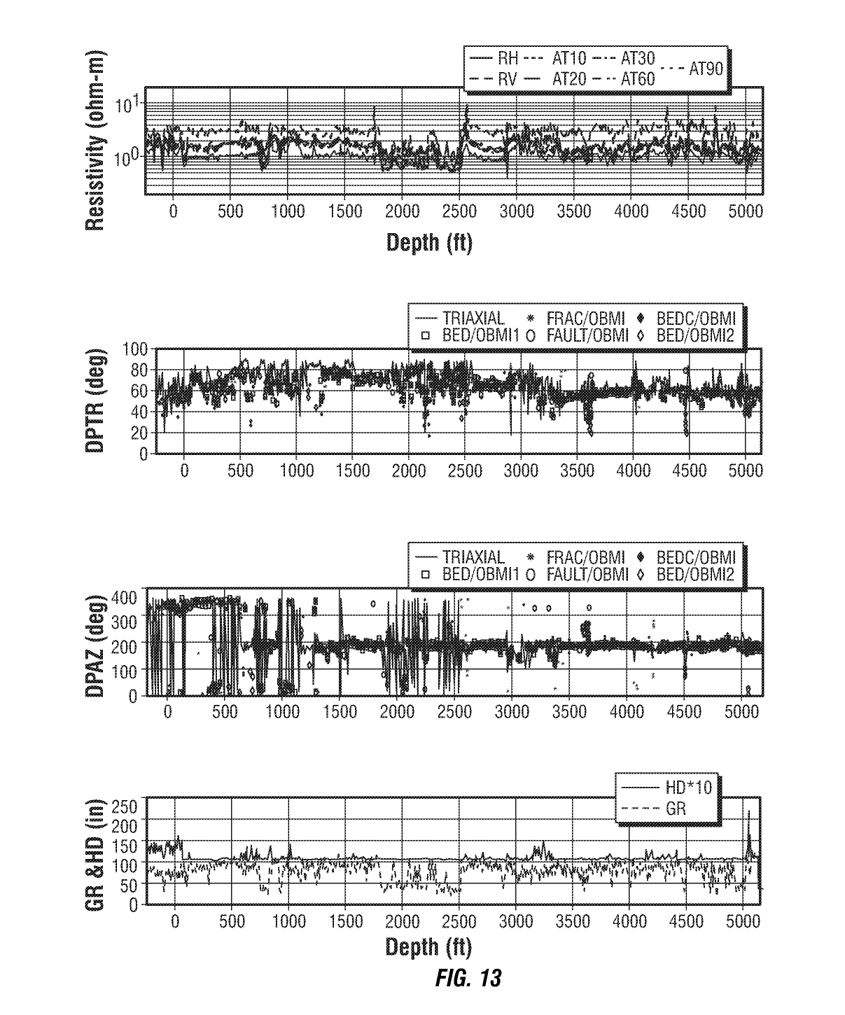

FIG. 13 shows triaxial induction data recorded from an actual wellbore filled with oil based mud, inverted dip magnitude and azimuth curves and a comparison with image-derived dip and azimuth. The Rh and Rv curves are shown in the top track as curves 102 and 100, respectively. The two foot resolution array induction curves are shown as thin curves 104. The true dip (DPTR) is shown on the second track together with image-derived dips shown with various symbols: squares represent manually selected bed dips from a first geologist, diamonds represent manually selected bed dip from a second geologist, stars represent fracture dip, circles represent a fault, and dots represent automatically selected least squares fit dip. The wellbore is almost vertical from top to bottom. Therefore, the true dip is almost the same as the apparent dip. The dip azimuth (DPAZ) computed by inversion of the triaxial induction data is shown on the third track together with the image derived azimuths in the same symbols as dip. The gamma ray and wellbore diameter are shown on the bottom track as curves 106 and 108, respectively. The particular well represented by the data in FIG. 13 was drilled near the flank of a salt dome. The gamma ray curve 106 shows many laminated shale and sand zones over a 5000 foot interval.

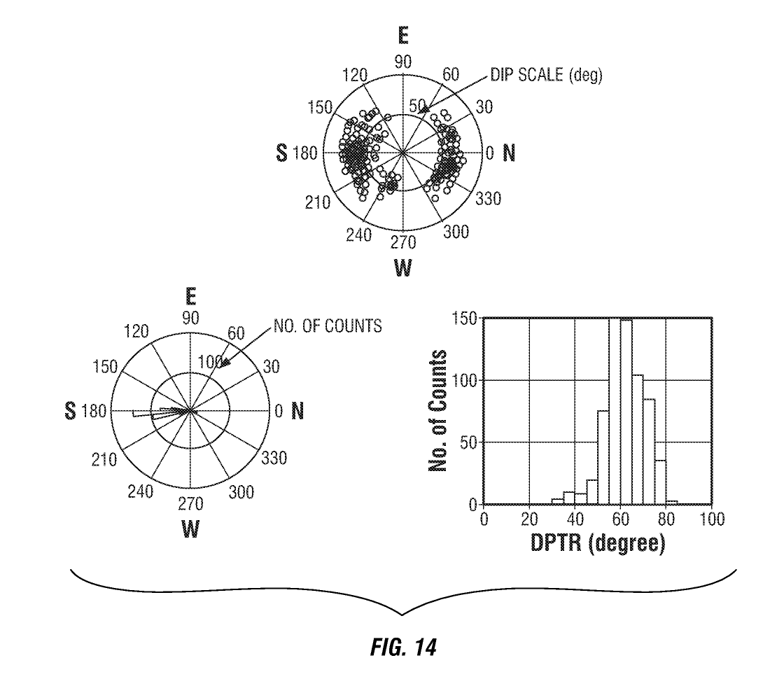

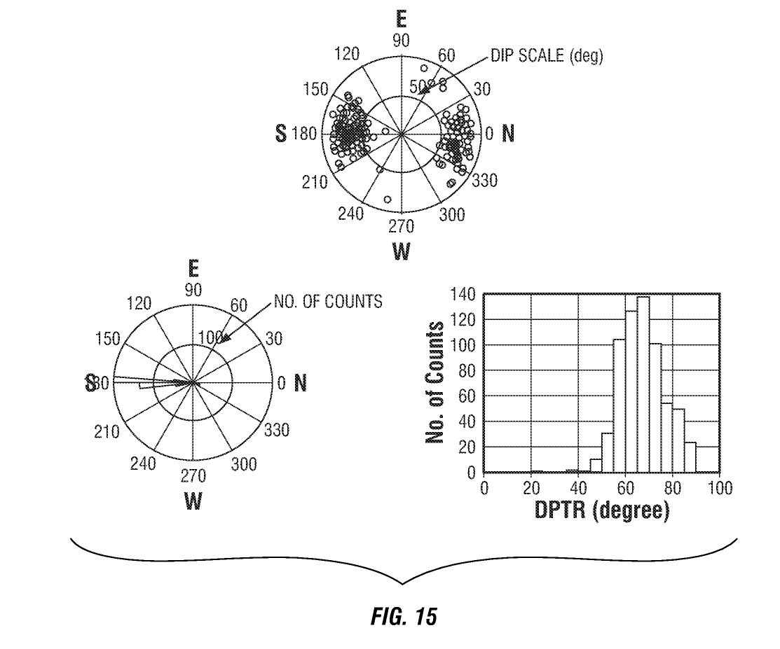

In the present example of a method according to the invention, the gamma ray curve 106 can be used as a discriminator to identify shale zones, which for this example is defined as a gamma ray value greater than 60. FIG. 14 shows the statistics of the dip and azimuth manually selected from an image instrument measurements in the shale zones. The dip and azimuth are plotted in polar coordinate format on the top center. The dip magnitude is displayed as radius. The azimuth North (0 deg.), East (90 deg.), South (180 deg.), and West (270 deg.) are in the X, Y, −X, and −Y axis directions, respectively. A histogram of the azimuth (rosette plot) is on the lower left. A Cartesian histogram of the dip is shown on the lower right. The azimuths of the vast majority of the shale beds are 180 degrees (strike is east-west direction). The dips are mostly around 60 degrees. There are hardly any high dip angles above 80 degrees. At all the same sampling points of the oil based mud manually selected dips and azimuths shown in FIG. 14, the triaxial induction derived dips and azimuths and plotted statistics are shown in a similar manner in FIG. 15. The azimuth of the shale beds derived from triaxial induction instrument are also distributed tightly around 180 degrees. The dips are mostly around 65 degrees. There are significantly more dips above 80 degrees than those manually selected from the image instrument measurements. Because of the large difference in the measurement length scales between the imaging instrument and the induction instrument, the dip and azimuth determined by the measurements made by these two different instruments, in principle could be quite different unless the formation is substantially uniform. FIGS. 14 and 15 suggest that statistically, in the shale zones, the triaxial derived dip and azimuth are very close to the manually selected dip and azimuth from the imaging instrument measurements. Therefore, the triaxial induction instrument dip results could be used effectively and efficiently to understand and construct large scale structure dip maps of the formations. The physics of how the current flows in the 3-5 ft sphere centered on the transmitters and receivers determines the dip and azimuth. The results are objective and relatively immune to borehole rugosity. The processing is fast and automatic. The results are available every sample interval (e.g., 3 inches). It is much easier to identify a trend in dip and azimuth using 3-inch sampled data instead of sparely sampled, manually selected image based data.

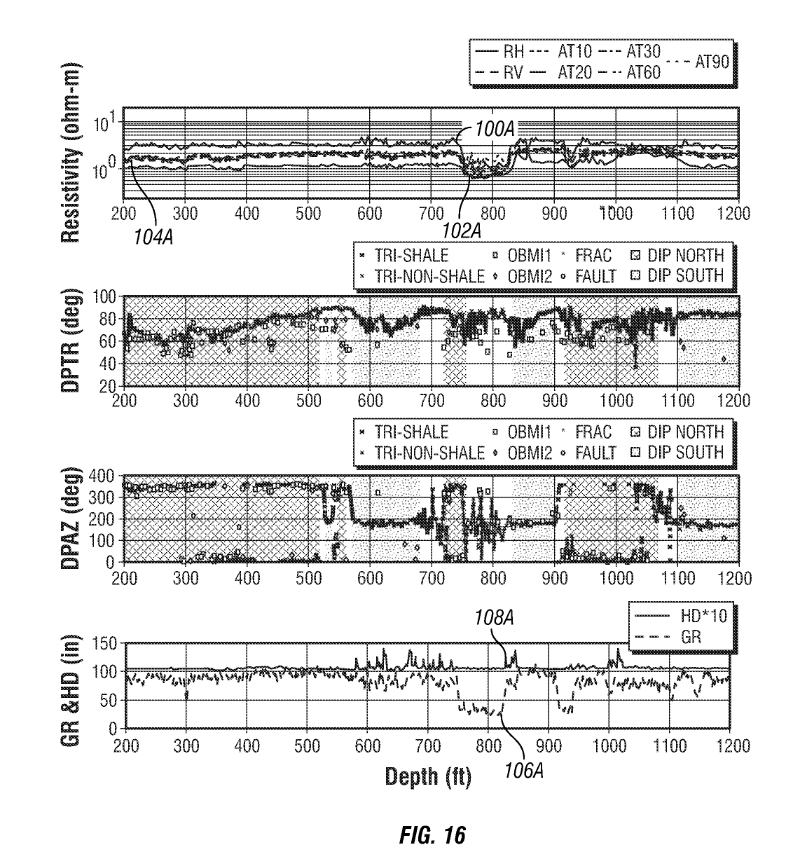

FIG. 16 is an expanded view of the curves shown in FIG. 13 over a depth range of 200-1200 ft., wherein the dips are relatively high, to illustrate how efficiently one could use the triaxial induction data inverted dip and azimuth to derive a formation structure map. In FIG. 16, the dips are coded in shale and sand, respectively, so that the geologist or interpreter could easily identify the shale zone dip as structure dip. The footage is shaded one way if the azimuth is near north (0 or 360 deg.) and the other way if the azimuth is near south (180 deg.). The 3-inch sampled triaxial dip and azimuth (track 2 and 3) show some very interesting and revealing trends. From 300 to 500 ft, the dips are steadily increasing from 60 to almost 90 degrees while the dip azimuths are generally toward the north. The image selected dips in this zone are quite scattered such that it is more difficult to identify the increasing dip magnitude trend. The image azimuths, however, are quite consistent with those from the inverted triaxial induction data and are generally toward the north. Between 500 to 570 ft, the triaxial induction inversion determined dips remain above 85 degrees while the azimuths are showing several flips between north and south. This is the characteristic pattern for dip angles near vertical. Several similar patterns near 90 degrees dip show 180 degrees flip of the azimuth occurring near 700, 900, and 1100 ft. The 180 degrees flip of azimuth between both shoulders of a high dip is a strong indication that the dip in the middle is truly near 90 degrees.

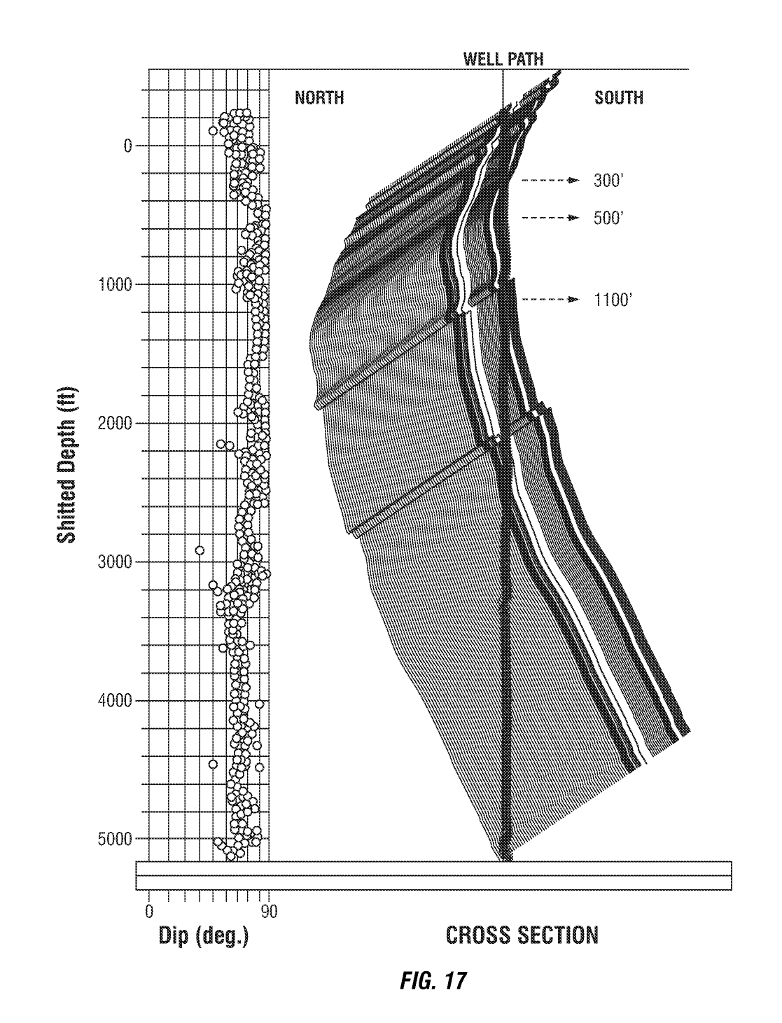

Based on the triaxial induction determined dip and azimuth, a structure cross-section map of the entire 5000 foot interval can be derived easily as shown in FIG. 17. The wellbore trajectory is substantially vertical through an allochthonous salt canopy into the formations below the salt. The triaxial induction derived dips are represented by short black lines crossing the indicated wellbore trajectory. From 300 to 500 ft, the dips are increasing from 60 to 90 degrees as the well passes thorough the increasing dip formations folded over by the salt canopy. The fold places older rocks on top of younger rocks. The dips are steady toward north. Between 500 to 1100 ft is a zone near the apex of the bend. The dips are generally very high and the azimuths flip several times between north and south. Below 1100 ft, the well penetrated the bottom sheet of the fold where the normal pattern of younger rock on top of older formations is restored. The dips are steady toward south. The matches are remarkably well in the top and bottom section of this fold. Near the apex of the fold, the seismic section is blurring due to the lack of resolution. Many intricate structural details such as those shown in FIG. 17 cannot be observed in surface exploration methods, such as reflection seismic surveying. The triaxial induction derived dip and azimuth could provide more fine scale detail information of the structure to augment the relatively large length scale seismic cross-section. The present example demonstrates that triaxial induction instrument tool is useful for studying reservoir structure in a length scale of several feet and up, such as bars, reefs, channels, fault, depositional current pattern, and other reservoir compartmentalization issues.

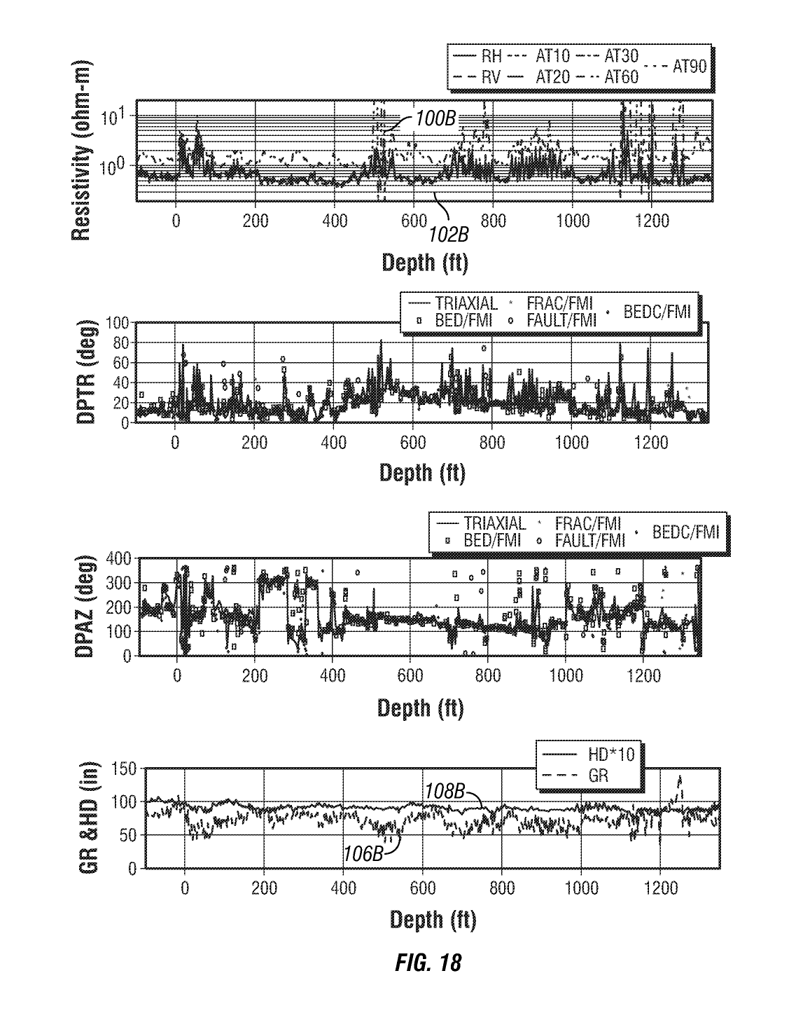

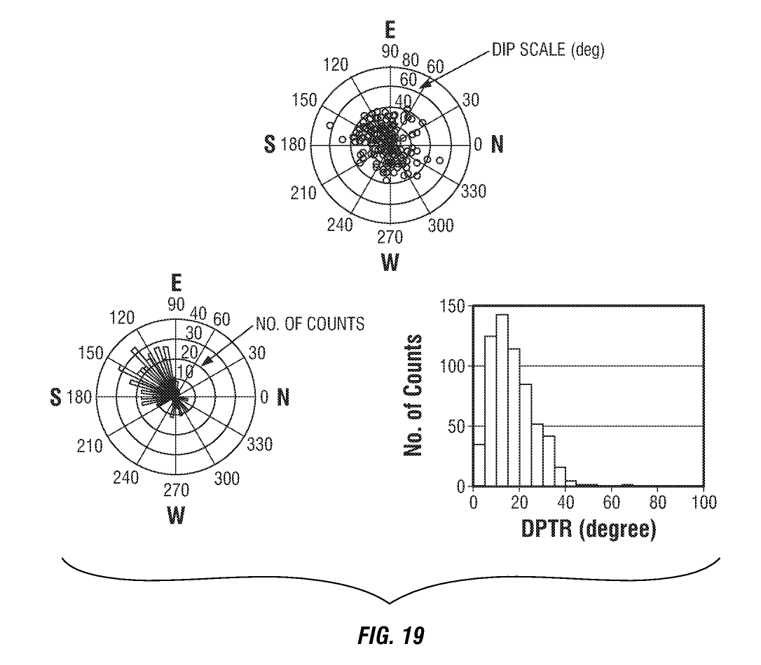

A water based mud wellbore field example and a comparison with image derived dip and azimuth will now be explained with reference to FIGS. 18-20. Water based mud imaging instrument generally have much better resolution than imaging instruments configured for oil based mud, and therefore can offer more detailed formation structure information. FIG. 19 shows triaxial induction data inverted curves and a comparison with image-derived dip and azimuth. The Rh 104B and Rv 102B curves are shown in the top display track. The 2-ft resolution array induction curves are shown at 104B. The true dip (DPTR) is shown on the second display track together with image derived dips using various symbols: squares for manually selected dip, stars for fracture dip, circles for faults, and dots for automatic least squares fit dip. The wellbore is almost vertical with inclination generally less than 5 degrees. The dip azimuth (DPAZ) is shown on the third track together with the image-derived dip azimuths in the same symbols as dip. The gamma ray 106B and wellbore diameter 108B are shown on the bottom track. The gamma ray curve 106B shows that the formation is mostly shaly with, many thin, laminated sand zones scattered throughout the surveyed interval.

FIG. 19 is also plotted with a highly compact depth scale for the purpose of showing the overall trend of the degree of match between triaxial dip and azimuth and those from image. In general, the triaxial induction inverted dips and image derived dips are remarkably well matched.

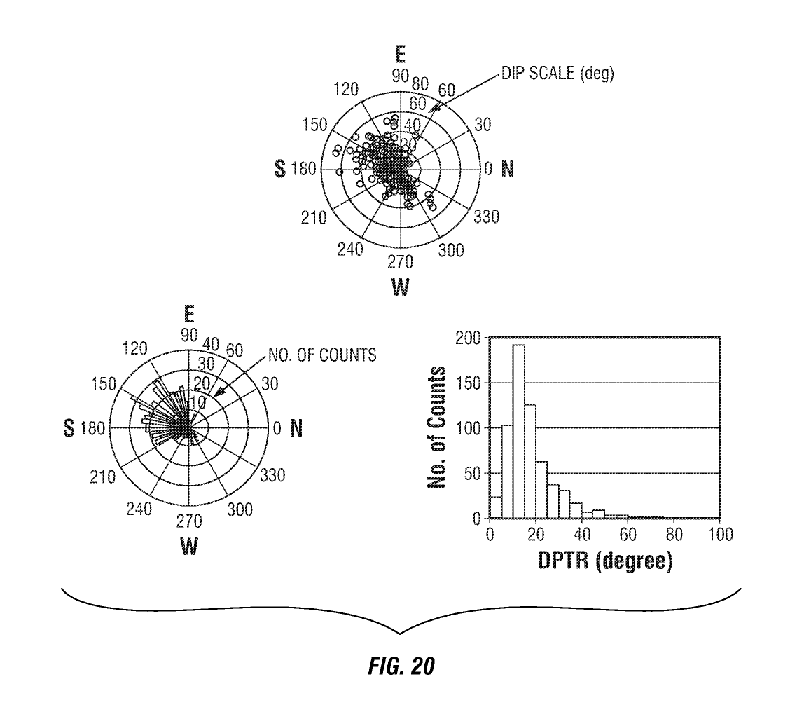

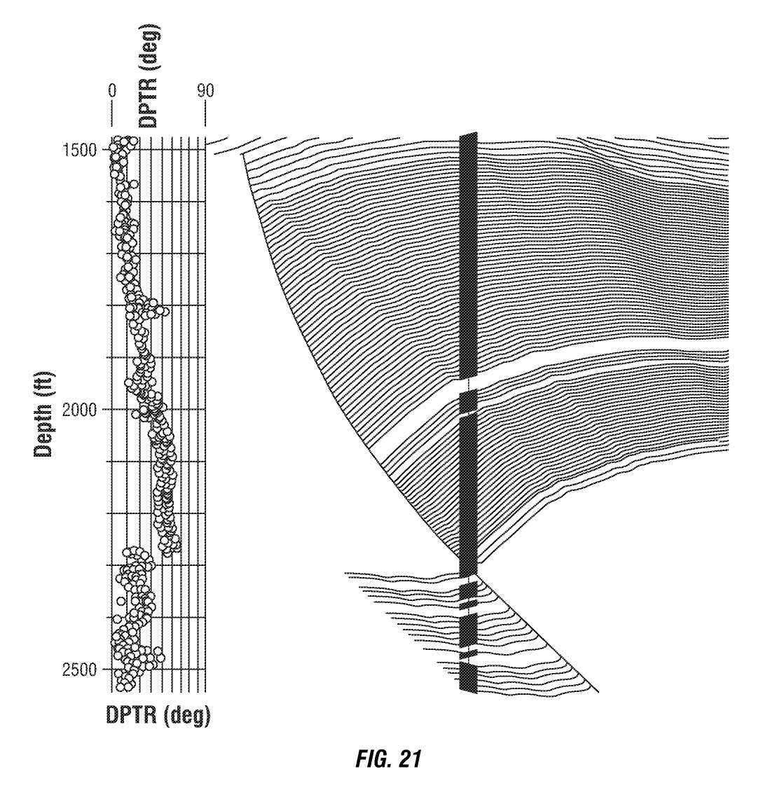

In a similar manner, the gamma ray curve 106B can be used as a discriminator for shale zones, which in the present example may be defined as a gamma ray measurement greater than 60. Shown in FIGS. 20 and 21 are the statistics of the dip and azimuth from image manually selected bed dips in the shale zones and the corresponding triaxial induction inversion results at the image sample points, respectively. The shale zone dip and azimuth statistics from the triaxial induction measurements are very similar to those from the manually selected image-based results. The dip angle distribution peaks at about 15 degrees and the azimuth distribution is mostly toward south-east. Small differences in statistics may be attributed to the heterogeneity of the formation. It will be appreciated by those skilled in the art that each well or geographic area may require different thresholds for shale and/or may benefit from the use of different clay responsive sensors than the gamma ray example shown herein.

FIG. 21 shows an example structure map made using the dips determined by inverting the triaxial induction measurements shown in FIG. 18. The dip trends with respect to depth may be interpreted as a roll over fault intersecting the wellbore at a depth of about 2800 feet.

Methods for determining dip using inversion processing or triaxial electromagnetic induction measurements may provide increased dip measurement density, can be easily and quickly computed, and may provide less subjective results than dip determination using manual selection from imaging device measurements.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for determining structural dip of subsurface formations, comprising:
accepting as input multiaxial induction measurements made by passing electric current through a multiaxial transmitter disposed in a wellbore drilled through subsurface rock formations, and detecting voltages induced in a multiaxial receiver disposed at a longitudinally spaced apart location along the wellbore while moving the transmitter and receiver along the wellbore;
inverting the multiaxial voltage measurements into values of formation dip magnitude and formation dip azimuth;
measuring a parameter related to shale content of the rock formations; and
determining structural dip of the rock formations by selecting dip magnitude and dip azimuth values occurring when the parameter exceeds a selected threshold.

2. The method of claim 1 wherein the parameter comprises gamma ray intensity.

3. The method of claim 1 further comprising measuring voltages induced in a plurality of longitudinally spaced apart triaxial receivers.

4. The method of claim 1 wherein the voltage measurements comprise three orthogonal direct coupled components and six cross-coupled components.

5. The method of claim 1 further comprising generating a structural map of the rock formations using the determined structural dip.

6. A method for well logging, comprising:
moving a multiaxial induction well logging instrument along a wellbore drilled through subsurface rock formations, the instrument including at least one multiaxial induction transmitter and at least one multiaxial receiver longitudinally spaced apart from the transmitter;
passing electric current through the transmitter; detecting voltages induced in the receiver;
inverting the detected voltages into values of dip magnitude and dip azimuth of the rock formations;
measuring a parameter related to shale content of the rock formations; and
determining a structural dip of the rock formations at locations along the wellbore wherein the measured parameter exceeds a selected threshold.

7. The method of claim 6 wherein the parameter comprises gamma ray intensity.

8. The method of claim 6 further comprising measuring voltages induced in a plurality of longitudinally spaced apart triaxial receivers.

9. The method of claim 7 wherein the voltage measurements at each receiver comprise three orthogonal direct coupled components and six cross-coupled components.

10. The method of claim 6 wherein the voltage measurements at the receiver comprise three orthogonal direct coupled components and six cross-coupled components.

11. The method of claim 6 further comprising generating a structural map of the rock formations using the determined structural dip.

12. The method of claim 6 wherein the instrument is moved at the end of an armored electrical cable.

13. The method of claim 6 wherein the instrument is coupled within a pipe moved along the wellbore.
